(19) United States
(12) Patent Application Publication
(10) Pub. No.: US 2022/0090573 A1
(43) Pub. Date: Mar. 24, 2022

(54) Submerged/Water-Level Turbine

(71) Applicant: Jacob Joseph Torres, Lake Barrington, IL (US)

(72) Inventor: Jacob Joseph Torres, Lake Barrington, IL (US)

(21) Appl. No.: 16/948,539

(22) Filed: Sep. 23, 2020

(51) Int. Cl. F03B 13/10

(52) U.S. Cl. CPC F03B 13/10; F05B 2240/14; F05B 2220/32

(57) ABSTRACT

The Submerged/Water-Level Turbine is a hydro-electric power generator. All possible designs characteristically generate power from a turbine by channeling a vertical flow of water to and from depths of a provided reservoir. Careful construction will be able to accommodate a full range of power demands by regulating the water level of the reservoir that surrounds the structure.

### CROSS-REFERENCES TO RELATED APPLICATIONS

Not Applicable

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### REFERENCE TO A “SEQUENCE LISTING”, TABLES, OR COMPUTER PROGRAM APPENDIX

Not Applicable

### STATEMENT REGARDING PRIOR DISCLOSURES BY THE INVENTOR OR A JOINT INVENTOR

Not Applicable

### BACKGROUND OF THE INVENTION

I am not certain about technical fields of the prior art.

### BRIEF SUMMARY OF THE INVENTION

Please read forward

### DESCRIPTIONS OF THE DRAWINGS

Not applicable

### DETAILED DESCRIPTIONS OF THE INVENTION

The Submerged/Water-Level Turbine is essentially a single channel of water used to generate electrical power from a turbine located somewhere near the exhaust port. It basically consists of the intake to a small diameter tube, that supplies an upward flow of water to a large diameter tube with a much greater volume force. From there, the flow moves down through the turbine and returns to the same reservoir from which it came. Please note; both the intake and the exhaust must remain submerged in order to operate.

Again, this is the basic design. Multiples of its construction can be arranged in any size/configuration, above ground, below ground, or along any substantial incline.

Additional features may include: more than one intake; synchronized channel locks; structural/chemical water conditioners; lengthening/widening of the exhaust, etc., etc.

Another consideration is periodic restart; this might employ mechanically-forced commutation, a fill point at the vertical apex, or, simply raising the Water-Level all the way above the structure.

Again I repeat, in a controlled environment the water level of the reservoir may be regulated in order to accommodate a full range of power demands.

1. The basic design of the Submerged/Water-Level Turbine may be improved upon in order to achieve maximum efficiency.
